(19) United States
(12) Patent Application Publication
(10) Pub. No.: US 2004/0173759 A1
(43) Pub. Date: Sep. 9, 2004

(54) Device, set and method for carrying a gas or a liquid to a surface through a tube

(76) Inventors: Hans W.P. Koops, Ober-Ramstadt (DE); Andreas Reinhardt, Hainburg (DE)

Correspondence Address: Woodling Krost & Rust, 9213 Chillicothe Road, Kirkland, OH, 44094, US

(21) Appl. No.: 10/362,180

(22) PCT Filed: Aug. 23, 2001
(86) PCT No.: PCT/EP01/09745

(30) Foreign Application Priority Data
Aug. 26, 2000 (DE) 100 42 098.2

(51) Int. Cl. G01N 21/01; G01N 23/10

(52) U.S. Cl. 250/428; 250/492.2

(57) ABSTRACT

The invention relates to a device, to a set of tubes and to a method for carrying a gas or a liquid to a surface through a tube, especially in order to produce gas mixtures or to treat the surface using gas lithography. The tube or in the case of a set, each tube of the set has an inlet opening and an outlet opening. A shaft is allocated to each tube, this shaft being arranged in the axial direction of the tube and being displaceable in its longitudinal direction in relation to the tube, from a first position to a second position and vice versa. Each shaft bears a blocking body which blocks or unblocks the outlet when the shaft is in the first or second position. A gas reservoir and a supply line by which means the inside of the gas reservoir is connection to the inlet opening of each tube are also allocated to each tube, so that gas is able to flow from the insider of the gas reservoir into the tube.

### TECHNICAL AREA

The invention pertains to a device, to a set, and to a method for supplying gas or liquid through a tube to a surface or into a space, especially for the purpose of processing the surface by means of gas lithography.

### STATE OF THE ART

To process the surface of, for example, a sample by gas lithography, it is necessary to induce a chemical reaction on the surface. This is done by supplying a certain gas or gas mixture or various gases or gas mixtures either simultaneously or in succession to the surface to be processed. For this purpose the sample is located in an evacuated vessel, through the wall of which the gas is supplied. In addition, the area of the sample where the chemical reaction is intended to occur is exposed to a particle beam such as an electron or ion beam or to a photon beam, which supplies the local excitation energy required for the reaction. In this way, the goal is achieved that the gas reacts with the sample only in those areas where the particle beam or the photon beam strikes the surface. Because the contact point of the particle beam or photon beam on the surface can be controlled very precisely from the outside, very specific areas can be subjected to the desired chemical reaction with very great precision. When a particle beam is used, a higher degree of 3-dimensional resolution can be achieved than when a photon beam is used. When a photon beam is used, the energy of the individual photons is typically a few electron volts.

The types of chemical reactions which occur depend on the material of the sample, on the type of gas, and on the intensity of the excitation energy. In particular, it is possible through the appropriate choice of these factors for the reaction to lead to the deposition of a layer such as a monolayer or a sequence of monolayers of certain atoms or molecules on the surface; this process is called additive, constructive, or build-up gas lithography. In this way, it is possible to coat surfaces, for example, where, by means of appropriate control of the particle beam or photon beam, a coating with a predetermined form or 3-dimensional structure can be produced. For example, it is possible in this way to apply very fine conductor pathways to the surface or microscopically small, doped semiconductor elements.

Conversely, through the suitable choice of the factors indicated above, it is also possible for the chemical reaction to form volatile reaction products so that certain portions of the surface can be removed; this type of process is referred to as subtractive, destructive, or erosive gas lithography. Thus, through appropriate control of the particle beam or photon beam, depressions of predetermined form can be produced in the surface. If a conductive layer, for example, has been deposited from the vapor phase onto a certain area of the surface before the start of the reaction, it is possible to remove undesired parts of this conductive layer and thus again to produce very fine conductor pathways.

Additive, 3-dimensional particle beam lithography is known from the publication by H. W. P. Koops et al. entitled “High Resolution Electron Beam Induced Deposition”, Proc. 31^{st} Int. Symp. on Electron, Ion, and Photon Beams, J. Vac. Sci. Technol. B 6(1) (1988) 477. The removal of material from surfaces by means of selective chemical etching supported by particle-beam radiation is described for several materials in the publication by S. Matsui et al. in Appl. Phys. Lett. 51 1498 (1987) and from the publication by J. W. Coburn et al. in J. Appl. Phys. 50, 3189 (1979). In the case of additive nanolithography, a cannula is usually used to supply the gas to the surface to be processed. The cannula also fulfills a second purpose at the same time, namely, to throttle and to meter the gas flow.

Gas feed devices for supplying the gas required to process the surfaces of a sample in deposition and dry-etching systems, for example, are known. A conventional gas feed device for gas lithography for processing the surface of a sample has a cannula to supply the gas and a mixing chamber opening into the cannula, to which chamber one or more gas supply tanks are connected so that they can be shut off when desired. The gas supply tanks contain different types of gases, and it is often necessary to prevent cross-contamination between them. It is thus necessary to prevent significant quantities of these gases from coming in contact with each other. In these cases the individual types of gases are therefore not conducted simultaneously but rather in succession from the individual gas supply tanks through the mixing chamber and the cannula to the surface. But because at least a residue of this gas remains in the mixing chamber after the required amount has been supplied, to avoid cross-contamination this chamber must either be evacuated by a pump or purged by a purging gas to remove the residual gas remaining in the mixing chamber before the other type of gas can be sent through.

A disadvantage of the conventional gas supply devices is that this residual gas, the volume of which corresponds to that of the mixing chamber, is lost and therefore cannot be used again. The gases required for gas lithography, however, are often extremely expensive and/or highly aggressive, toxic, or damaging to the environment. There is also the problem that certain gases sold for the purpose of gas lithography are not off-the-shelf items; on the contrary, they must be first be produced to order, which increases the cost of the overall process and the amount of time required even more. Therefore, the loss of such gases explained above can lead to a noticeable increase in the cost of the process, and at the same time it can also lead to a non-negligible contamination of the environment, which can be avoided only at considerable additional cost.

The desired pressure of the gas in the mixing chamber is adjusted by bringing the mixing chamber to a specific, predetermined temperature by means of a heating/cooling device. In addition to the problem of cross-contamination, there is therefore in many cases the additional difficulty that the conventional gas supply system does not make it possible to adjust the gas pressure separately for each of the various gases. For example, it is possible for one type of gas to condense at a temperature which corresponds to the desired gas pressure of one of the other gases to be used. Independently of the problem of cross-contamination, therefore, the fact that the pressure of the various types of gases cannot be adjusted separately means that the conventional gas supply systems cannot be used to supply different types of gases to the surface simultaneously. When different types of gases are supplied successively, however, the temperature must be reset and adjusted each time, which slows down the process considerably.

Even in cases where only a single type of gas is used, losses still occur in the conventional gas feed systems. Such losses of gas occur when, for example, work on one sample has been completed and the gas feed is stopped so that the finished sample can be removed and replaced with a new one. For this purpose, it would be possible to shut off the connection between the gas supply tank and the mixing chamber. The disadvantage of this, however, is that, because the mixing chamber would still be under the pressure of the gas at the moment the connection is shut off, gas would continue to escape from or diffuse out of the mixing chamber and through the cannula even after the connection was shut off. This would continue until the gas no longer had any pressure. The larger the volume of the mixing chamber and the cannula, the larger the loss of gas.

For this reason, conventional gas feed systems have a second shut-off device, which is installed as close as possible to the cannula. The gas loss now involves only the partial volume of the gas feed system downline from the second shut-off device. This partial volume is referred to in the following as the “dead volume”. Because of space limitations and for reasons of mechanical strength, however, the second shut-off device cannot be located in the cannula itself or in its immediate vicinity. The cannula itself—the intrinsic volume of which, however, is usually negligible—and especially the relevant part of the mixing chamber continue to constitute a dead volume of considerable size.

Another disadvantage of the conventional gas feed systems is that, because of the relatively large volume of the mixing chamber, a transport gas must often be added to the treatment gas, especially when only a small amount of gas is to be conducted to the surface. This transport gas is needed to generate the minimum pressure in the mixing chamber required to initiate the flow of gas through the cannula. As a result, the cost and the complexity of the apparatus are increased; in addition, the presence of the transport gas impedes the reaction of the gas which has been transported in this way to the surface, which decreases in turn the useful yield which can be achieved from the gas during the reaction.

The invention is therefore based on the task of providing a device, a set, and a method for supplying gas or liquid through a tube to a surface or into a space, especially for the purpose of processing that surface by gas lithography, by means of which the disadvantages of the state of the art described can be avoided.

This task is accomplished according to the invention by a device for supplying gas or liquid through a tube to a surface, especially for the production of gas mixtures or for additive or subtractive processing of the surface by gas lithography, characterized in that

the tube has an inlet and also an outlet, located at one end, the diameter of the outlet being smaller than the inside diameter of the tube;

a shaft, which extends longitudinally through the tube, can be moved axially with respect to the tube from a first to a second position and back again to the first position;

a blocking element, which is able to seal off the outlet, is mounted on the front end of the shaft in such a way that it blocks the flow of the gas or liquid through the outlet when the shaft is in the first position and releases it when the shaft is in the second position; and

the inlet is connected by a gas feed line to the interior space of a gas supply tank, so that the gas is able to flow from the interior space of the gas supply tank, through the gas line and the inlet, and into the tube.

The task is also accomplished by a set of tubes for supplying gas or liquid to a surface, especially for producing gas mixtures or for the additive or subtractive processing of surface by gas lithography, characterized in that

each tube has an inlet and also an outlet, located at one end, the diameter of the outlet being smaller than the inside diameter of the tube in question;

each tube has a shaft, which extends longitudinally through the tube and which can be moved axially with respect to the tube from a first position to a second position and back again to the first position;

a blocking element (18a), which is able to seal off the outlet, is mounted on the front end of each shaft in such a way that it blocks the flow of the gas or liquid through the outlet when the shaft is in the first position and releases it when the shaft is in the second position; and

each tube has a gas supply tank and a gas feed line, which connects the interior space of the gas supply tank to the inlet of each tube, so that gas is able to flow from the interior space of each gas supply tank, through the gas feed line and the inlet, and into the tube.

The task is also accomplished by a method for supplying gas or liquid through a tube to a surface, especially for producing gas mixtures or for the additive or subtractive processing of the surface by gas lithography, characterized in that:

the tube has an inlet and also an outlet, located at one end, the diameter of the outlet being smaller than the inside diameter of the tube;

a shaft, which extends longitudinally through the tube, can be moved axially with respect to the tube from a first to a second position and back again to the first position;

a blocking element, which is able to seal off the outlet, is mounted on the front end of the shaft in such a way that it blocks the flow of the gas or liquid through the outlet when the shaft is in the first position and releases it when the shaft is in the second position; and

the inlet is connected by a gas feed line to the interior space of a gas supply tank, so that the gas is able to flow from the interior space of the gas supply tank, through the gas line and the inlet, and into the tube,

where the shaft is brought into the first position to block the supply of gas or liquid to the surface and into the second position to release it.

The task is also accomplished by a method for supplying gas or liquid through a set of tubes to a surface, especially for producing gas mixtures or for the additive or subtractive processing of the surface by gas lithography, characterized in that

each tube has an inlet and also an outlet, located at one end, the diameter of the outlet being smaller than the inside diameter of the tube in question;

each tube has a shaft, which extends longitudinally through the tube and which can be moved axially with respect to the tube (21) from a first position to a second position and back again to the first position;

a blocking element (18a), which is able to seal off the outlet, is mounted on the front end of each shaft in such a way that it blocks the flow of the gas or liquid through the outlet when the shaft is in the first position and releases it when the shaft is in the second position; and

each tube has a gas supply tank and a gas feed line, which connects the interior space of the gas supply tank to the inlet of each tube, so that gas is able to flow from the interior space of each gas supply tank, through the gas feed line and the inlet, and into the tube, where the shaft is brought into the first position to block the supply of gas or liquid to the surface and into the second position to release it.

The gas supply tank does not necessarily have to contain gas exclusively. Instead, it can also contain a liquid or a solid, from which the gas can form by evaporation, vaporization, or sublimation.

In a preferred embodiment of the invention, the front end of the shaft is inside the tube, whereas the other end projects beyond the tube in the direction opposite the flow of gas, that is, in the direction toward the end of the tube which faces away from the outlet, so that the rear part of the shaft is located outside the tube. The rear part is connected to a drive, which is able to move the shaft from the first position to the second position and back again to the first position.

According to an advantageous embodiment, a bellows is provided inside the tube, at the end of the tube facing away from the outlet. One end of the bellows is connected permanently and in a gas-tight manner by welding or by the use of an adhesive, for example, to the inside wall of the tube. The other end of the bellows is connected permanently and in a gas-tight manner to the shaft. The shaft can therefore be shifted back and forth longitudinally inside the tube while stretching and compressing the bellows, during which movement a gas-tight seal is maintained in the area where the shaft leaves the tube. In addition to its sealing function, the bellows can also serve simultaneously as an elastic restoring element for returning the shaft to the first or second position. The bellows can be made of metal, rubber, or plastic.

The drive can comprise a first piston, a first restoring spring, and a first cylinder with an opening for the supply of compressed air, where the first cylinder is aligned with the axial direction of the shaft, where the rear part of the shaft projects into the first cylinder, where the first piston is free to move back and forth in the first cylinder and is connected to the rear part of the shaft, and where the first piston is able to move the shaft into one of the two position, i.e., either the first or second position, when compressed air is supplied through the opening in the first cylinder and load is thus exerted on the first restoring spring and to move the shaft into the other one of the two positions, i.e., the second or first position, when the compressed air is discharged from the first cylinder and the load on the first restoring spring is relaxed. In this embodiment, therefore, the shaft is moved in one direction by compressed air and in the other direction by the force of a spring.

In a preferred variant of this embodiment of the invention, the first piston is able to move the shaft into the second position when compressed air is supplied through the opening in the first cylinder and load is exerted on the restoring spring and to move the shaft into the first position when the compressed air is discharged from the first cylinder and the load on the restoring spring is relaxed. In this embodiment, the shaft is moved into the second position—corresponding to the release of the outlet—by the supply of compressed air, whereas the shaft is moved into the first position—corresponding to the blocking of the outlet—by the force of a spring. In this design, therefore, the shaft advantageously always returns automatically to the first position in the absence of compressed air, such as when there is a pause in the work. In a variant of the invention, the restoring function of the restoring spring is taken over by a bellows.

The drive can be designed so that is controlled mechanically, electrically, or electronically or by an EDP device. A control system of this type can also be combined in particular with a drive operating with compressed air and the force of a spring as explained above, in that, for example, the supply of compressed air is controlled by an electrically actuated shut-off valve. When a set is used, preferably each drive can be individually controlled by mechanical, electrical, or electronic means or by an EDP device.

In a preferred embodiment of the invention, the blocking element is located completely inside the tube and is shaped in such a way that, when the shaft is in the second position, the gas or liquid can flow around it. When the shaft is in the first position, the blocking element seals off the outlet on the side of the outlet facing the interior of the tube. When the shaft is in the second position, the blocking element is a certain distance away from the outlet in the interior of the tube, and the gas or liquid can flow around it. It is thus possible for the gas or liquid to flow through the tube and to escape through the outlet.

In one embodiment of the invention, the outlet has a circular cross section, and the end of the blocking element facing the outlet is conical in shape. When the shaft is in the first position, the tip of the cone engages in the outlet. These designs of the outlet and of the blocking element are especially suitable for ensuring a tight seal when the shaft is in the first position. The lateral surface of the cone can in particular be coated or covered with an elastic sealing material.

The inlet is preferably located in a lateral surface of the tube, so that the end of the shaft which faces the drive advantageously does not project through the inlet.

In one embodiment of the invention, the freedom of axial movement of the shaft is limited by at least one stop, so that the shaft can move only between the first and the second position.

A cannula, which is open at both ends, can be mounted on the tube. The cannula communicates with the outlet and has an inside diameter which is smaller than that of the tube. A cannula of this type is advantageous especially when the gas is to be conducted with precision to the surface of a sample for the purpose of additive or subtractive gas lithography. The cannula thus serves to supply the gas precisely to the area of the surface which is to be processed, but it also serves simultaneously to throttle the gas flow to a predetermined rate and thus to prevent both the waste of gas and an excessive drop in the pressure of the gas in the tube.

When a set of tubes is used, each of the gas supply tanks can contain a different gas. Each tube, furthermore, can lead to a cannula, and each cannula can, if needed, have a different diameter and a different form. As a result, the conditions under which several different gases are supplied to the surface can be easily adjusted with precision at the same time.

The blocking element does not seal off one part of the tube from another when it blocks the flow of gas or liquid; instead, it blocks only the outlet, which is located at the end of the tube. The invention therefore avoids the disadvantage of the formation of a dead volume in the tube; that is, the entire volume of the tube is blocked off, so that, after the outlet has been sealed, there is no partial volume of the tube remaining unblocked, from which a residue of gas or liquid could still escape. When a cannula is used, only its volume represents a dead volume, but in most cases this is completely negligible. The significant reduction in the dead volume achieved according to the invention is especially advantageous when the type of gas conducted through the tube to the surface is to be replaced by another.

When a set according to the invention is used, there is no longer any need to design the tube as a gas mixing chamber. It is therefore possible in many cases to decrease the volume of the tube considerably, as a result of which the dead volume is reduced even more; in addition, the need to add a transport gas to the gas can often be completely eliminated, which is obviously advantageous.

In another advantageous embodiment, the cannula is connected in detachable fashion to the tube by a screw-type, a clamping, a snapping, a friction-fit, or a bayonet type of mechanism. The cannulas can therefore be replaced quickly and easily.

In a preferred embodiment of the invention, the gas supply tank can be heated by a heating element and/or cooled by a cooling element for the purpose of influencing the pressure of the gas inside the tank. The temperature of the gas supply tank can be controlled by an open-loop or a closed-loop circuit. The gas feed line, the tube, and the cannula can also be set up so that they can be heated and/or cooled, and the temperature of the gas line and/or of the tube and/or of the cannula can also be controlled by an open-loop or a closed-loop circuit. Because of the isothermal conditions under which all the components through which the gas flows can be maintained, it is possible to ensure a uniform pressure and to prevent local condensation of the gas. It is advantageous for these components to be surrounded by a thermally insulating material. The heating of certain individual components can be accomplished by thermal conduction from one component to another, thus eliminating the need for individual heaters for each component.

When a set is used, each gas supply tank can preferably be heated individually by a heating element and/or cooled individually by a cooling element for the purpose of influencing the pressure of the gas inside the tank, and the temperature of each gas supply tank can be controlled individually by either an open-loop or a closed-loop circuit. The gas feed lines, tubes, and cannulas can also be heated and/or cooled, where each tube forms an assembly together with the gas feed line opening into the tube and with the cannula opening into the tube, and the temperature of each assembly can be controlled individually by an open-loop or a closed-loop circuit. As a result, the gas pressure can advantageously be adjusted independently for each type of gas used, which makes it possible to optimize the operating conditions and to achieve a significant acceleration in the course of the process in comparison with the state of the art. Here the tubes and/or the gas supply tanks and/or the gas feed lines can be thermally insulated against their environment, especially for the purpose of preventing the formation of local low-temperature zones.

An important area of application of the invention is the supply of gas to a surface of a sample for the additive or subtractive processing of the surface by gas lithography. In this application, the sample must be held in a vacuum chamber or negative pressure chamber, that is, in a housing enclosed by walls. In one embodiment of the invention, therefore, the tube is located on the outside surface of a housing, which has an opening, and the tube is arranged so that it projects through the opening, the inlet of the tube being on the outside of the housing, the outlet on the inside.

In one embodiment of the invention, the tube can be shifted in its axial direction by an adjusting mechanism from a first position to a second position and back to the first position again. This is advantageous, for example, when, after a sample has been processed by the gas supplied to it, the tube, possibly including the cannula which may be attached to it, is to be retracted after the gas feed has been turned off, so that the sample can be removed without the danger of contact between it and the tube or the cannula (and thus without any damage to the sample). The adjusting mechanism is preferably designed to be controlled either mechanically, electrically, or electronically or by means of an EDP device.

In a preferred embodiment of the invention, the drive and the adjusting mechanism can be controlled centrally by a common EDP device. In an advantageous elaboration, the temperature of the gas supply tank and the temperature of the gas feed line and/or of the tube and/or of the cannula can be subjected centrally to open-loop or closed-loop control by the common EDP device. The tube and/or the gas supply tank and/or the gas feed line can be thermally insulated with respect to their environment to suppress as completely as possible the formation of local temperature differences or cold zones.

When a set is used, it is possible in particular for each tube to be given its own adjusting mechanism, so that each of the tubes can be shifted individually in the axial direction. This can be advantageous in situations where, for example, different gases are to be conducted in succession through the individual tubes and cannulas directly to a precise point on the surface of a sample, and where the tips of the cannulas are to be prevented from interfering with each other. It is preferable that each adjusting mechanism be controlled individually by mechanical, electrical, or electronic means or by an EDP device.

When a set is used, it is possible in particular for the tubes to be mounted on or in a common carrier. When the carrier is shifted, therefore, all the tubes are shifted in common, which is advantageous. An arrangement in which the tubes are essentially parallel to each other and all the outlets lie in essentially the same plane, perpendicular to the axis of the tubes, is especially advantageous.

So that the carrier and thus the tubes can be shifted, the carrier is, in a preferred embodiment of the invention, mounted on a support body and can be shifted with respect to this support body in the direction of the surface from a rest position to a working position and back again. This is advantageous, for example, when a sample has been processed by the supply of gas from several tubes and the tubes, possibly including the cannulas attached to them, are to be retracted in common upon completion of the gas feed. This is the case, for example, when the sample—as usual in the practice of gas lithography—is mounted for processing on a movable table, which, after the sample has been processed, is moved into a specific position to allow the sample to be removed. When in this case the carrier is located in the working position, there is the danger that the cannulas could come in contact with the table, as a result of which the cannulas could be bent or damaged. It is advantageous to select the rest position in such a way that such contact can be reliably avoided.

The carrier is shifted with respect to the support body preferably by means of a displacement mechanism. This can comprise a second piston, a second restoring spring, a rod, and a second cylinder with an opening through which compressed air can be supplied. The second cylinder is aligned axially with the rod, and one end of the rod projects into the second cylinder, while the other end is connected to the carrier. The second piston moves back and forth in the second cylinder and is connected to the first end of the rod. This second piston is able to move the carrier into one of the two positions, i.e., either the rest position or the working position, by the action of compressed air, which is supplied through an opening in the second cylinder thus acts against the force of the second restoring spring, whereas the second piston is able to move the carrier into the other one of the two positions, i.e., the working position or the rest position, when the compressed air is discharged from the second cylinder and the load on the second restoring spring is thus relaxed. In this embodiment, therefore, the carrier is driven in one direction by compressed air and in the other direction by the force of the spring. In a different embodiment, the carrier is driven in both directions by compressed air, and the displacement mechanism is set up to be bistable, so that, in the absence of compressed air, the carrier remains stably either in the working position or in the rest position.

In a preferred design of this embodiment, the second piston is able to move the carrier into the working position when compressed air is supplied through the opening in the second cylinder and load is thus exerted on the second restoring spring and to move the carrier into the rest position when the compressed air is discharged from the second cylinder and the load on the second restoring spring is thus relaxed. In this design, therefore, the carrier always returns automatically to the rest position in the absence of compressed air such as during pauses in operation, for example, which is advantageous.

The displacement mechanism can be designed so that it is controlled centrally by either mechanical, electrical, or electronic means or by an EDP device. A control system of this type can also be combined with a displacement mechanism which is operated by compressed air and the force of a spring, as explained above, in that the supply of compressed air is controlled by an electrically actuated shut-off valve.

When a set is used, it is possible in particular for each drive and each adjusting mechanism to be controlled individually by a common, central EDP device. In an advantageous elaboration, the temperature of each gas supply tank and the temperature of each assembly can be subjected centrally to open-loop or closed-loop control by the common EDP device. In addition, the displacement mechanism can also be controlled centrally by either mechanical, electrical, or electronic means or by the common EDP device.

In a preferred embodiment of the invention, the movement of the carrier with respect to the support body is guided by a guide device so that the movement remains directionally stable, that is, so that the carrier is prevented from tilting with respect to the support body. This can be done, for example, by permanently attaching at least one guide rod or guide rail to the carrier or to the support body. The rod or rail either extends around the other component, i.e., the support body or carrier, or the other component engages laterally with the rod or rail.

In one embodiment of the invention, the gas supply tanks are mounted on the carrier and thus move along with it. In this case, the gas feed lines do not need to be flexible, which means, for example, that tubes can be used instead of hoses for the feed lines.

In an embodiment of the invention especially for the purpose of additive or subtractive processing of the surface by gas lithography, the support body is mounted on the outside surface of a housing, in which an opening is provided. The carrier is arranged to project through the opening so that the inlets of the tubes are located outside the housing and the outlets of the tubes inside the housing. In this way, it is possible to supply gas from the outside into the housing and thus to the surface of the sample while enjoying all the advantages of the invention.

The housing can in particular be the boundary walls of a vacuum chamber, which is part of an apparatus for gas lithography and which contains a sample with the surface to be processed. The apparatus also comprises a source, which generates a controllable beam of charged particles or photons to the surface. The surface is thus irradiated locally by the beam and/or bombarded with the particles. The ability to control the beam means, for example, that its intensity, direction, and focus can be controlled, but it can also mean that the energy of the particles or the wavelength of the photons can be selected.

In one embodiment of the invention, the device according to the invention or the set according to the invention is part of an apparatus of this type, in which the beam can also be centrally controlled by the common EDP device.

According to another preferred embodiment of the invention, all of the previously mentioned open-loop and closed-loop control functions are executed centrally by the common EDP device, so that all these functions can be coordinated with each other by the EDP program thus made to work together with each other in optimal fashion. Thus all the steps involved in the processing of the sample can be coordinated and automated.

When guide rods are used to guide the movement of the carrier with respect to the support body and thus maintain its directional stability, the guide rods can simultaneously serve to hold the support body on the wall. In another embodiment, the support body is integrated into the wall of the housing.

To implement the additive or subtractive reaction, it is advantageous to use several tubes, either simultaneously or in succession, to provide a mixture of monomolecular layers on the surface and to use the particle beam to convert this mixture into the new material or into the volatile components of the material to be etched. Advantage can be taken of the reaction kinetics of the molecules involved by using the particle beam to provide the additional energy required to ignite the reaction locally, or light of a suitable wavelength can be used as a source of additional energy to pre-excite the mixture to prepare it for the reaction, whereupon a particle beam is used to ignite the reaction locally. So that a certain number of monolayers of defined molecular composition can be selectively applied to or removed from the surface, a molecular beam or several simultaneous molecular beams can be used to replenish the supply of precursors required for the deposition or etching material. These molecular beams can be produced by gas channels operating in parallel, which have been preadjusted to operate in the required pressure range through adjustment of their temperatures. The molecules are then conducted through the cannulas under central EDP control of the individual gas flow rates and directed at a defined molecular flow rate onto the surface to be processed.

The gas or gases are conducted to the surface from an individual feed line according to the invention or simultaneously from several feed lines according to the invention. The materials mix together in the condensed molecular layers on the sample. Chemical reactions with the appropriate stoichiometry can thus be conducted by supplying the required reaction energy in the form of a particle beam. The cannulas are preferably preadjusted so that the molecular beams are concentrated on the working area.

It is advantageous for the gas flow rates and the particle or photon beam to be controlled and coordinated centrally, which is made possible by the present invention. These parameters can advantageously be determined before the start of processing and then stored in the memory of the EDP device. Various processing programs can be stored in an electronic library, which can be called up as needed.

When a set is used, gases from at least two different gas tanks can be supplied to the surface simultaneously, which means that different gases can be supplied in parallel to the surface through separate feed routes. The gases thus come in contact with each other only after they have reached the surface, as a result of which the danger of cross-contamination within the gas feed system is avoided, and the limitations on the choice of gases often encountered when conventional gas feed systems are used are advantageously eliminated. This feature of the invention also prevents the gases or the vapors or liquids they form from reacting chemically with each other during the gas feed phase, which is especially important when high gas concentrations are being used. Such reactions can take place only after the gases have arrived at the surface or have condensed on the surface.

In another variant, the gases are supplied to the surface from at least two of the gas tanks one after the other, so that, for example, the surface can be subjected to different chemical reactions in succession.

In particular, the gas can be supplied to the surface for the purpose of processing by gas lithography, where, for the purpose of exciting a chemical reaction between the gas or gases and the material of the surface, the surface can be irradiated by a controllable beam of particles such as electrons, ions, or protons. In another variant, the gas is again supplied to the surface for the purpose of processing by gas lithography, where, for the purpose of exciting a chemical reaction between the gas or the gases and the material of the surface, the surface is irradiated with a controllable beam of photons, e.g., a laser beam. The beam of particles or photons can be concentrated or focused on a specific area of the surface by a lens. In particular, it is also possible for the beam also to be controlled centrally by the common EDP device. In a variant, the surface is irradiated simultaneously by a beam of particles and by a beam of photons, both of which can be controlled centrally by the common EDP device.

The invention makes it possible to meter the gas or gases very precisely. Because of the very small dead volume, the starting and stopping of the gas feed through the tube can be controlled advantageously as a function of time, in such a way that a specific quantity of gas can be conducted to the surface. This specific quantity exceeds a predetermined minimum value but does not exceed a predetermined maximum value, which means that the stoichiometry of the chemical reaction is determined by the controlled timing of the starting and stopping of the gas feed.

In a similar manner, the starting and stopping of the gas feed can also be controlled as a function of time when a set is used in such a way that a specific quantity of a first gas is conducted to the surface through at least one of the tubes and a second specific quantity of a second gas is conducted through at least one of the other tubes, where the first specific quantity exceeds a first predetermined minimum value but does not exceed a first predetermined maximum value, and where the second specific quantity exceeds a second predetermined minimum value but does not exceed a second predetermined maximum value, which means that the stoichiometry of the chemical reaction is determined by the controlled timing of the starting and stopping of the gas feed. The metering of the gas feed through each tube can thus be accomplished so precisely that the stoichiometry of the overall chemical reaction is determined by the appropriately controlled timing of the starting and stopping of the gas feed through each of the tubes in question.

In a variant, the gas or gases and the material of the surface are selected so that an exothermic chemical reaction between the gas, the gases, or one of the gases and the material of the surface begins by itself on arrival of the gas or gases at the surface in such a way that, as a result of the chemical reaction, at least some of the surface is covered by a layer or a layer is removed. As a result, a layer of considerable surface area can be applied to the surface of a sample or removed from it. Thus the surface can be provided, for example, with a conductive or with a nonconductive layer or prepared in some other way so that it can be provided with an even finer structure in a following processing step by means of an additional chemical reaction, which is brought about, for example, by the supply of a different set of gases and with the help of a particle beam or a photon beam.

In another variant, the gas or gases and the material of the surface are selected so that an exothermic or endothermic chemical reaction takes place between the gas, the gases, or one of the gases and the material of the surface in the area of the surface exposed to the particle beam or photon beam and only there, in such a way that, as a result of the chemical reaction, the area of the surface irradiated by the beam is covered by a layer or a layer is removed. In the case of an exothermic chemical reaction, the beam of particles or photons supplies only a portion of the excitation energy required during the course of the chemical reaction, whereas the remainder of this energy originates from the chemical reaction itself.

In this way, through appropriate control of the beam of particles or photons, the location of the chemical reaction can be determined very precisely and limited to a specific area, namely, to the area irradiated by the beam of particles or photons.

In another variant,

(a) first, at least two different types of gas are conducted in alternation to the surface, and

(b) then at least two different gases are conducted simultaneously or in succession to the surface,

so that the surface is subjected to a specific, predetermined, stepwise sequence of processing operations, consisting in particular of the addition or removal of a layer from the surface. In another embodiment of this variant, steps (a) and (b) are repeated cyclically several times.

A short description of the drawings:

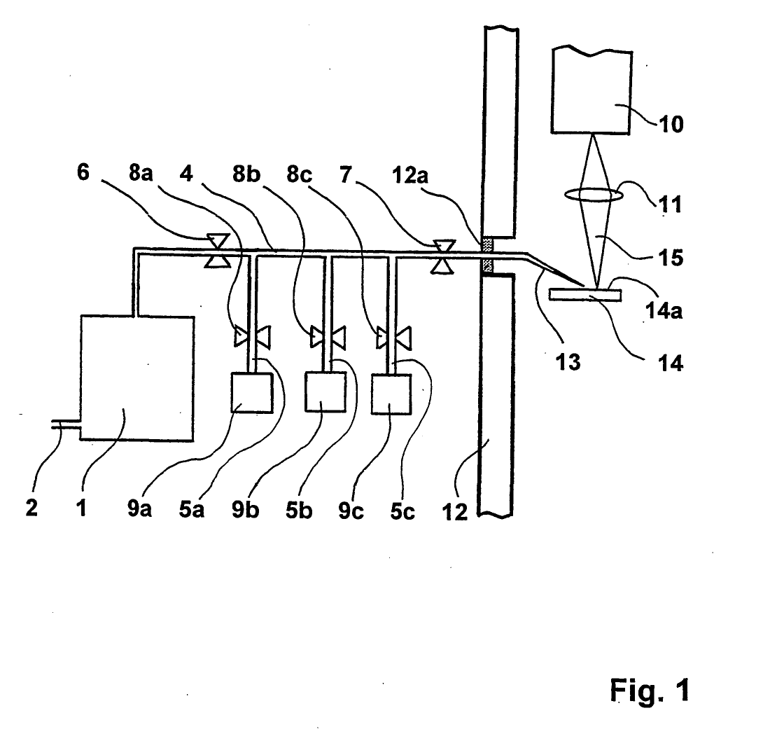

FIG. 1 shows a schematic, cross-sectional diagram of a conventional gas supply system for gas lithography as further explanation of the state of the art;

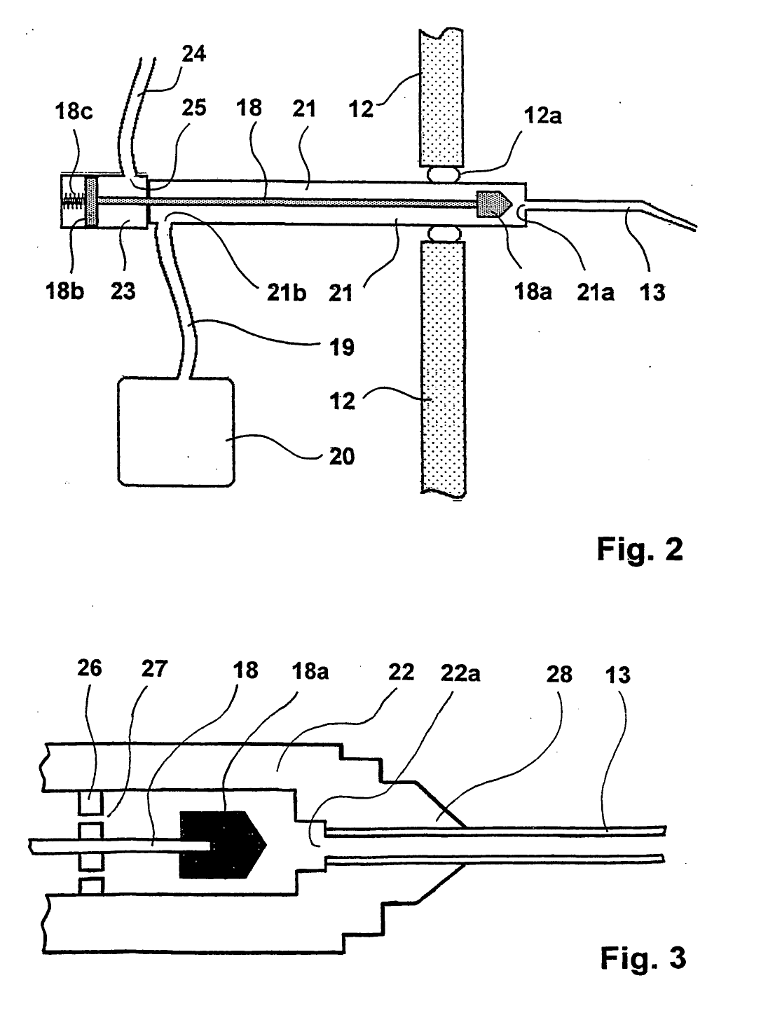

FIG. 2 shows a schematic, cross-sectional diagram of an embodiment of a device according to the invention, which projects through a wall of a vessel;

FIG. 3 shows a schematic, cross-sectional diagram of part of another embodiment of a device according to the invention; and

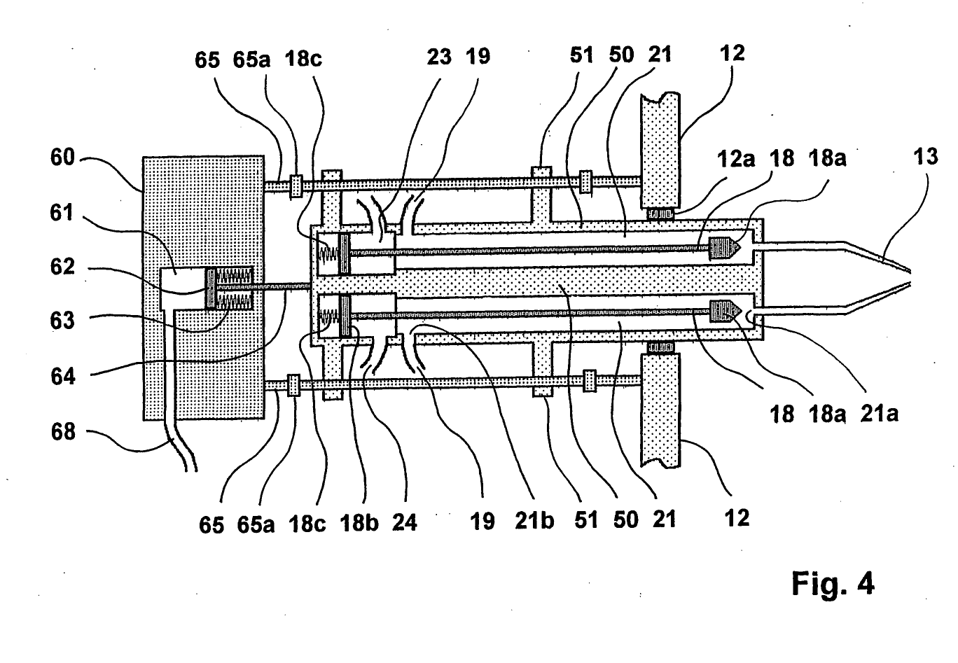

FIG. 4 shows a schematic, cross-sectional diagram of a set according to the invention.

To serve as further explanation of the state of the art, FIG. 1 shows a schematic, cross-sectional diagram of an example of a conventional gas supply system for gas lithography. In a vacuum, which is enclosed by a wall 12, there is a sample 14, the surface 14a of which is to be processed by the use of various gases. For this purpose, a beam 15 of charged particles, e.g., electrons or ions, or a beam 15 of photons emitted by a source 10, is focused on the surface 14a by a lens 11. In the case of a beam of charged particles, the lens 11 is, of course, an electron lens.

Gas supply tanks 9a, 9b, 9c are connected to a mixing chamber 4 by feed lines 5a, 5b, 5c, each of which can be shut off by a stop valve 8a, 8b, 8c. The mixing chamber has two outlets, each of which can be closed by a stop valve 6, 7. The mixing chamber 4 projects through the wall 12, the pass-through opening being sealed by a gasket 12a. The chamber leads to a cannula 13, which terminates in the immediate vicinity of the surface 14a. It is usually possible for the mixing chamber 4 and the gas supply tanks to be heated individually, and they are usually thermally insulated against their environment.

When the processing of the surface is to begin, the stop valve 7 and one of the stop valves 5a, 5b, 5c are opened first, so that gas of a first type can flow from one of the gas supply tanks 9a, 9b, 9c, through the mixing chamber 4 and the cannula 13, to the surface 14a, where it is converted by a beam 15 into a permanent material by deposition, or where some of the sample 14 is converted by chemical reaction into volatile reaction products and thus removed. Heating elements (not shown) are used to bring the system to the temperature which corresponds to the gas pressure desired for the processing of the surface 14a with the first type of gas.

After the surface 14a has been processed to the desired degree by means of the first type of gas, the stop valve 5a, 5b, 5c in question is closed again. Because of the danger of cross-contamination, it is not possible to begin again immediately with the further processing of the surface 4 with a different type of gas; instead, the residue of the first type of gas remaining in the mixing chamber 4 must first be removed. For this purpose, the stop valve 7 is closed; the shut-off valve 6 is opened; and the gas residue is removed from the mixing chamber 4 by a pump 1 and discharged through an exhaust pipe 2. This gas residue is lost, which is disadvantageous. Because of space limitations and for reasons of mechanical strength, furthermore, the stop valve 7 cannot be installed as close to the cannula as might be desired, which means that there continues to be a certain quantity of the first gas type present between the shut-off valve 7 and the cannula, a quantity which cannot be removed by the pump 1. This quantity of gas is also lost, which means that the total loss of gas corresponds to the entire volume of the mixing chamber 4. The presence of this gas also means that there is the danger of cross-contamination.

Now the processing of the surface 1 4a with the second type of gas can begin, the work proceeding in a manner similar to that already described above. The temperature is brought to a value which corresponds to the gas pressure desired for the processing of the surface 14a with the second type of gas, which can be time-consuming in practice. The quantity of the first gas remaining between the stop valve 7 and the cannula is also lost and can also contribute to cross-contamination. When additional types of gas are used, the steps explained above are repeated in the same way until the processing of the surface 14a has been completed.

FIG. 2 shows a schematic, cross-sectional diagram of an embodiment of a device according to the invention for supplying gas or liquid through a tube 21 to a surface for additive or subtractive processing of the surface by gas lithography. The tube 21 projects through a wall 12 of an evacuated vessel (not shown), in which the sample (also not shown in FIG. 2) with the surface to be processed is located.

The tube 21 has a lateral inlet 21b and an outlet 21a at one end, the diameter of the outlet being smaller than the inside diameter of the tube 21. The pass-through opening for the tube 21 through the wall 12 is sealed by a gasket 12a. The inlet 21b is located outside the vessel, the outlet 21a inside the vessel.

The tube 21 is connected by the inlet 21b and a gas feed line 19 to a gas supply tank 20. It is advisable to a install a shut-off fitting in the gas feed line 19, but this is not shown in FIG. 2 for the sake of clarity. When the shut-off fitting is open, gas can flow from the gas supply tank 20 via the gas feed line 19, through the inlet 21b, and into the tube 21.

Inside the tube 21 is a shaft 18, which is coaxial to the tube 21 and which can be shifted in the longitudinal direction with respect to the tube 21 from a first position to a second position and back again.

The shaft 18 carries a blocking element 18a at one end. This element 18a is able to seal off the outlet 21a and is arranged in such a way that it prevents gas from flowing through the outlet 21a when in the shaft is in the first position but allows the gas to flow when the shaft is in the second position.

The blocking element 18a, the front end of the shaft, and the middle part of the shaft 18 are all inside the tube 21. The blocking element 18a is shaped so that, when it is in the second position of the shaft 18, the gas can flow around it and the outlet 21a is open. The other end of the shaft 18 projects out beyond the tube 21 in the direction opposite that of the gas flow, that is, in the direction toward the end of the tube facing away from the outlet 21a. The shaft 18 thus projects from the end of the tube 21 facing away from the outlet 21a so that its other end is outside the tube 21. The tube is closed at the end facing away from the outlet 21a; this end, however, has a central bore, through which the shaft 18 can pass in a gas-tight manner. This bore serves simultaneously to guide the movement of the shaft 18 between the first and second positions in a directionally stable manner.

The outlet 21a has a circular cross section. The end of the blocking element 18 facing the outlet 21a has a conical shape. When the shaft is in its first position, the tip of the cone engages with the outlet 21a, and the lateral surface of the cone rests against the inside circumferential edge of the outlet 21a.

The other end of the shaft 18 is connected to a drive, which is able to move the shaft 18 from the first to the second position and back again. The drive comprises a first piston 18b, a first restoring spring 18c, and a first cylinder 23 with an opening 24 for the supply of compressed air. The first cylinder 23 is mounted at the end of the tube 21 facing away from the outlet and is aligned axially with the shaft 18. The rear part of the shaft 18 projects into the first cylinder 23. The first piston 18b is free to move back and forth in the first cylinder 23 and is connected to the rear part of the shaft 18. Under the action of compressed air, which is supplied to the interior of the first cylinder 25 through a compressed air line 24 and the opening 25, the piston 18b moves in the direction away from the tube 21. It thus compresses the first restoring spring 18c and moves the shaft 18 into the second position, so that the outlet 21a is opened.

Conversely, when compressed air is discharged from the first cylinder 23, the first piston 18b moves under the force of the first restoring spring 18c back toward the tube 21. It thus pushes the shaft 18 back into the first position, in which the outlet 21a is blocked. The movement of the shaft 18 is therefore driven in one direction by compressed air and in the other direction by the force of the spring. The first restoring spring 18c is preferably pretensioned in such a way that it continues to exert a force on the piston 18b even after the shaft 18 has reached its first position. This force tries to push the piston toward the outlet 21a, which means that, when there is no compressed air in the first cylinder 23, the blocking element 18a is pressed against the outlet 21a. This has the effect of improving the tightness of the seal produced at the outlet 21a.

A cannula 13, which is open at both ends, communicates with the outlet. The cannula 13 is used to deliver the gas precisely to the point on the surface which is to be processed. A beam of charged particles and/or photons (not shown in FIG. 2 for the sake of clarity) is also directed at this area to excite a chemical reaction between the gas and the surface. The cannula 13 simultaneously serves the purpose of throttling and metering the gas flow.

The movement of the shaft 18 with respect to the tube 21 is preferably guided by an additional guide device, not shown in FIG. 2. This device consists in one embodiment of the invention of a guide plate 26 (FIG. 3), which is mounted in the interior of the tube near the blocking element 18, crosswise to the longitudinal axis of the tube. The shaft 18 passes through the center of this plate. The guide plate 26 also has off-center openings 27, through which the gas can flow.

In a refinement of the design according to the invention, the tube 21 can be shifted in its axial direction by an adjusting mechanism from a first position to a second position and back again. As a result, the tube 21, including the cannula 13 attached to it, can be moved in the direction leading away from the sample. The gas outlet end of the cannula 13 is thus pulled back from the sample. This is advantageous with respect to the handling of the sample in the vessel, especially after the processing of the surface is completed and the sample is to be removed without the danger of contact between the cannula 13 and the sample (which could possibly damage the cannula 13 or the sample).

In a preferred embodiment of the invention, the system consisting of the gas supply tank 20, the gas feed line 19, the tube 21, and the cannula 13 can be heated by at least one heating element (“hot wall system”, not shown) and/or cooled by at least one cooling element (not shown) for the purpose of controlling the gas pressure, where the temperature can be automatically regulated so that a certain, predetermined gas pressure is maintained. The gas pressure is recorded by a manometer (not shown).

FIG. 3 shows a schematic, cross-sectional diagram of part of a different embodiment of a device according to the invention with a very small dead volume. Part of a tube 22 in the area of its outlet 22a, the front end of the shaft 18, the blocking element 18a, part of the cannula 13, the area of the entrance to the outlet 22a, and a guide plate 26 with off-center openings 27 are shown. In the area of the outlet 22a, the tube 22 has an extension 28 in the form of the frustum of a cone, which is coaxial to the tube 22. This extension serves to hold the cannula 13 firmly. The holder of the cannula is therefore integrated into the tube 22. In a preferred embodiment of the invention, the cannula 13 is connected detachably to the tube by means of a fastening mechanism (not shown), which can be in the form of, for example, a screw type, a clamping, a snapping, a friction-fit, or a bayonet type mechanism. As a result, the cannula 13 can be quickly and easily exchanged for another one of a different length, a different diameter, or a different shape.

The guide plate 26 serves to guide the shaft 18 with respect to the tube 22 in a directionally stable manner and also serves to stabilize the centering of the blocking element 18a with respect to the outlet 22a. The shaft 18 passes through the center of the guide plate 26. The guide plate 26 has several off-center openings 27, through which the gas can flow, so that the gas flow is subject to little or no interference by the guide plate 26.

FIG. 4 shows a schematic, cross-sectional diagram of a set of tubes according to the invention for supplying gas or liquid to a surface for additive or subtractive processing of the surface by gas lithography.

Each tube 21 has a lateral inlet 21b and also an outlet 21a, located at one end, the diameter of the outlet being smaller than the inside diameter of the tube 21 in question. Each tube 21 has a shaft 18, which extends longitudinally through the tube 21 and which can be shifted with respect to the tube 21 in the axial direction of the tube 21 from a first position to a second position and back again. A blocking element 18a, which is able to seal off the outlet 21a, is provided at one end of each shaft 18 and is arranged in such a way that the blocking element 18a blocks the flow of the gas through the outlet 21a when the shaft 18 is in the first position and releases the flow when the shaft is in the second position. Each tube 18 also has a gas supply tank (not shown in FIG. 4) and a closable gas feed line 19, through which the interior of the gas supply tank is connected to the inlet 21b of each tube 21, so that in each case gas can flow from the interior space of the gas supply tank, through the gas feed line 19 and the inlet 21b, and into the tube, where each gas supply tank preferably contains a different type of gas.

Each shaft can be moved by a drive mechanism, which is operated with compressed air and the force of a spring, as already explained on the basis of FIG. 2. Each system consisting of the tube 21, the inlet 21b, the outlet 21a, the cannula 13, the shaft 18, the blocking element 18a, the gas supply tank, the gas feed line 19, and the drive mechanism thus corresponds essentially to the design of the device previously explained on the basis of FIG. 2. It is preferred that each system be set up so that it can be heated separately, so that the gas pressure can advantageously be adjusted independently for each type of gas being used.

The tubes 18 of the set are mounted in a common carrier 50. When the carrier 50 is shifted, therefore, all of the tubes 18 are shifted advantageously in common. So that the carrier 50 can be shifted in the direction of the sample (not shown in FIG. 4) and back in the opposite direction together with the tubes 18, the carrier 50 is mounted on a support body 60 and can be shifted with respect to this support body in the direction of the sample, i.e., the surface of the sample, from a rest position to a working position and back again, where the outlet ends of the cannulas are in the immediate vicinity of the surface when the carrier is in the working position and a certain distance away from it when the carrier is in the rest position.

In one embodiment of the invention (not shown), the gas supply tanks are also mounted on the carrier, so that they necessarily participate in the movement of the carrier. This also means that the gas lines do not need to be flexible. This embodiment can be advantageous in cases where, for example, aggressive gases are being used and no hoses sufficiently resistant to the gas are available as gas feed lines. In this case the gas feed lines can be designed as pipelines, possibly with an interior coating resistant to the gas.

The support body 60 is mounted on the external surface of a housing, i.e., on its wall 12. This means that a movement of the carrier 50 with respect to the support body 60 is at the same a movement with respect to the housing and thus with respect to the sample located in the housing. The housing has an opening, in which the carrier 50 is mounted so that it projects through the opening. The inlets 21b of the tubes 18 are therefore outside the housing, and the outlets 21a of the tubes 18 are inside the housing. It is thus possible for different gases to be supplied in parallel from the outside into the housing and to the surface of the sample while enjoying all the advantages of the invention.

The displacement of the carrier 50 with respect to the support body 60 is preferably accomplished by means of a displacement mechanism, which comprises a second piston 62, one or a pair of second restoring springs 63, a rod 64, and a second cylinder 61 with an opening for the supply of compressed air through a compressed air feed line 68. The second cylinder 61 is provided in the support body 60 in axial alignment with the rod 64. The rod connects the second piston 62 to the carrier 50. The second piston 62 can move back and forth in the second cylinder 61 and can push the carrier 60 into the working position under the action of the compressed air arriving in the interior of the second cylinder 61 through the compressed air feed line 68, the second piston thus exerting a load on the second restoring springs 63. Conversely, the carrier 50 is pushed by the second restoring springs 63 back into the rest position when the compressed air is discharged from the second cylinder 61. In the absence of compressed air, e.g., during interruptions in the processing work or when the compressed air supply system has failed, the carrier 50 therefore advantageously always returns automatically to the rest position.

The support body 60 is attached by guide rods 65 to the wall 12 of the housing. These guide rods 65 serve simultaneously to guide the movement of the carrier with respect to the support body 60 in a directionally stable manner. For this purpose, the carrier 50 has a plurality of guide arms 51, which extend around the guide rods 65 without play.

Commercial Feasibility:

The invention is commercially feasible in, for example, the areas of chemistry, bioengineering, medical technology, thin-layer technology, surface enhancement of optical components, corrosion-proofing, vacuum technology, and semiconductor production.

The key figure is FIG. 4.

List of Reference Numbers:

1 pump

2 exhaust pipe

4 mixing chamber

5a, 5b, 5c feed lines

6, 7 stop valves

8a, 8b, 8c stop valves

9a, 9b, 9c gas supply tanks

10 source

11 lens

12 wall

12a gasket

13 cannula

14 sample

14a surface of 14

15 beam from 10

18 shaft

18a blocking element

18b first piston

18c first restoring spring

19 gas feed line

20 gas supply tank

21, 22 tubes

21a, 22a outlet of 21

21b inlet of 21

23 first cylinder

24 compressed air feed line

25 opening in 23

26 guide plate

27 openings in 26

28 extension of 22

50 carrier body

51 guide projection

60 support body

61 second cylinder

1. Device for supplying gas or liquid through a tube (21, 22) to a surface (14a), especially for producing gas mixtures or for additive or subtractive processing of the surface (14a) by gas lithography, characterized in that
the tube (21, 22) has an inlet (21b) and also an outlet (21a, 22a), located at one end, the diameter of the outlet being smaller than the inside diameter of the tube (21, 22);
a shaft (18), which extends longitudinally through the tube (21, 22), can be shifted axially with respect to the tube (21, 22) from a first position to a second position and back again;
a blocking element (18a), which is able to seal off the outlet (21a, 22a), is mounted at the front end of the shaft in such a way that the blocking element (18a) blocks off the flow of the gas or liquid through the outlet (21a, 22a) when the shaft is in the first position and releases the flow when it is in the second position; and
the inlet (21b) is connected by a gas feed line (19) to the interior space of a gas supply tank (20), so that gas can flow from the interior of the gas supply tank (20), through the gas feed line (19) and the inlet (21b), and into the tube (21, 22).

2. Set of tubes (21) for supplying gas or liquid to a surface (14a), especially for producing gas mixtures or for additive or subtractive processing of the surface (14a) by gas lithography, characterized in that
each tube (21) has an inlet (21b) and also an outlet (21a), located at one end, the diameter of the outlet being smaller than the inside diameter of the tube (21) in question;
each tube (21) has a shaft (18), which extends longitudinally through the tube (21) and which can be shifted axially with respect to the tube (21) from a first position to a second position and back again;
a blocking element (18a), which is able to seal off the outlet (21a, 22a), is mounted at the front end of each shaft (18) in such a way that the blocking element (18a) blocks the flow of gas or liquid through the outlet 21a, 22a) when the shaft is in the first position and releases the flow when the shaft is in the second position; and
each tube has a gas supply tank (20) and a gas feed line (19), by which the interior space of the gas supply tank (20) is connected to the inlet (21b) of each tube (21), so that gas can flow in each case from the interior space of the gas supply tank (20), through the gas feed line (19) and the inlet (21b), and into the tube (21, 22).

3. Device according to claim 1 or a set according to claim 2, characterized in that the gas supply tank (19) contains a liquid or a solid, from which the gas is formed by evaporation, vaporization, or sublimation.

4. Device according to claim 1 or set according to claim 2, characterized in that the front end of the shaft (18) is inside the tube (21, 22), whereas it projects beyond the tube (21, 22) in the direction opposite the flow of gas, so that the rear part of the shaft (18) is outside the tube (21, 22), the rear part being connected to a drive, which is able to move the shaft (18) from the first to the second position and back again.

5. Device or set according to one of claims 1-3, characterized in that the blocking element (18a) is mounted completely within the tube (21, 22) and is shaped so that, when the shaft is in its second position, the gas or liquid can flow around it.

6. Device or set according to claim 4 or claim 5, characterized in that the drive comprises a first piston (18b), a first restoring spring (18c), and a first cylinder (23) with an opening (25) for the supply of compressed air, where
the first cylinder (23) is aligned with the axial direction of the shaft;
the rear part of the shaft (18) projects into the first cylinder (23);
the first piston (18b) is installed in the first cylinder (23) with freedom to move back and forth and is connected to the rear part of the shaft (18); and
the first piston (18b) is able to move the shaft (18) into one of the two positions, i.e., into either the first or second position, under the action of the compressed air supplied through the opening (25) in the first cylinder (23) and against the force of the first restoring spring (18c) and to move the shaft (18) into the other one of the two positions, i.e., into either the second position or the first position, when the compressed air is discharged from the first cylinder (23) and the load on the first restoring spring (18c) is released.

7. Device or set according to claim 6, characterized in that the first piston (18b) is able to move the shaft (18) into the second position under the action of the compressed air supplied through the opening in the first cylinder (23) and against the force of the first restoring spring (18c) and to move the shaft (18) into the first position when the compressed air is discharged from the first cylinder (23) and the load on the first restoring spring (18c) is released.

8. Device or set according to claim 4, characterized in that the drive can be controlled mechanically, electrically, or electronically or by an EDP device.

9. Set according to claim 8, characterized in that each drive can be controlled individually either mechanically, electrically, or electronically or by an EDP device.

10. Device or set according to claim 4, characterized in that a bellows is installed inside the tube (21, 22) at the end of the tube (21, 22) which faces away from the outlet (21a, 22a), one end of the bellows being connected permanently and in a gas-tight manner to the inside wall of the tube (21, 22), whereas the other end is connected permanently and in a gas-tight manner to the shaft (18), so that the shaft (18) can be moved with respect to the tube (21, 22) in the longitudinal direction of the tube under the expansion or compression of the bellows, and in that the area where the shaft (18) exits from the tube (21, 22) is sealed in a gas-tight manner.

11. Device or set according to claim 5, characterized in that the outlet (21a, 22a) has a circular cross section, and in that the end of the blocking element (18a) facing the outlet (21a, 22a) is conical in shape, where the tip of the cone engages in the outlet (21, 22a) when the shaft (1) is in its first position.

12. Device according to claim 1 or set according to claim 2, characterized in that the inlet (21b) is located in a lateral surface of the tube (21, 22).

13. Device according to claim 1 or set according to claim 2, characterized in that the freedom of axial movement of the shaft (18) is limited by at least one stop so that the shaft (18) can be moved only between the first and the second position.

14. Device according to claim 1 or set according to claim 2, characterized in that a cannula (13), which is open at both ends, is mounted on the tube (21, 22), which cannula communicates with the outlet (21a, 22a) and has a smaller inside diameter than the tube (21, 22).

15. Device or set according to claim 14, characterized in that the cannula (13) is connected detachably to the tube (21, 22) by means of a screw type, a clamping, a snapping, a friction-fit, or a bayonet type of mechanism.

16. Device according to claim 1, characterized in that the gas supply tank (20) can be heated by a heating element and/or cooled by a cooling element for the purpose of influencing the pressure of the gas inside it, and in that the temperature of the gas supply tank can be subjected to open-loop or closed-loop control.

17. Set according to claim 2, characterized in that each gas supply tank (20) has its own heating element so that it can be heated individually and/or has its own cooling element so that it can be cooled individually for the purpose of influencing the pressure of the gas inside it, and in that the temperature of each gas supply tank can be subjected individually to open-loop or closed-loop control.

18. Device according to claim 14, characterized in that the gas feed line (19), the tube (21, 22), and the cannula (13) can be heated and/or cooled, and in that the temperature of the gas feed line (19) and/or of the tube (21, 22) and/or of the cannula (13) can be subjected to open-loop or closed-loop control.

19. Set according to claim 14, characterized in that the gas feed lines (19), the tubes (21, 22), and the cannulas (13) can be heated and/or cooled, where each tube (21, 22), the gas feed line (19) leading to the tube, and the cannula (13) leading to the tube (21, 22) form an assembly (19, 21, 13), and in that the temperature of each assembly (19, 21, 13) can be subjected individually to open-loop or closed-loop control.

20. Device according to claim 1 or set according to claim 2, characterized in that the tube (21, 22) can be shifted in the axial direction by an adjusting mechanism from a first position to a second position and back again.

21. Set according to claim 20, characterized in that the adjusting mechanism can be controlled mechanically, electrically, or electronically or by an EDP device.

22. Set according to claim 20, characterized in that each tube (21) has its own adjusting mechanism.

23. Set according to claim 21, characterized in that each adjusting mechanism can be individually controlled either mechanically, electrically, or electronically or by an EDP device.

24. Set according to claim 2, characterized in that the tubes (21) are mounted on or in a common carrier (50).

25. Set according to claim 24, characterized in that the tubes (21) are essentially parallel to each other, and in that all the outlets (21a) lie essentially in the same plane, which is perpendicular to the axis of the tubes (21).

26. Set according to claim 24 or claim 25, characterized in that the carrier (50) is mounted on a support body (60) and can be shifted with respect to the support body in the direction of the surface (14a) from a rest position into a working position and back again.

27. Set according to claim 25, characterized in that the carrier (50) is shifted with respect to the support body (60) by a displacement mechanism.

28. Set according to claim 27, characterized in that the displacement mechanism comprises a second piston (62), a second restoring spring (63), a rod (64), and a second cylinder (61) with an opening for the supply of compressed air, where
the second cylinder (61) is axially aligned with the rod (64);
the first end of the rod (64) projects into the second cylinder (61), and the other end of the rod (64) is connected to the carrier (50);
the second piston (62) is installed in the second cylinder (61) with freedom to move back and forth and is connected to the first end of the rod (64); and
the second piston (62) is able to move the carrier (50) into one of its two positions, i.e., either the rest position or the working position, under the action of the compressed air supplied through the opening in the second cylinder (61) and against the force of the second restoring spring (63) and to move the carrier (50) into the other one of the two positions, i.e., the working position or the rest position, when the compressed air is discharged from the second cylinder (61) and the load on the restoring spring (63) is released.

29. Set according to claim 28, characterized in that the second piston (62) is able to move the carrier (50) into the working position under the action of the compressed air supplied through the opening in the second cylinder (61) and against the force of the second restoring spring (63) and to move the carrier (50) into the rest position when the compressed air is discharged from the second cylinder (61) and the load on the restoring spring (63) is released.

30. Set according to one of claims 24-29, characterized in that the gas supply tanks (20) are also mounted on the carrier (50).

31. Set according to one of claims 27-30, characterized in that the displacement mechanism can be controlled mechanically, electrically, or electronically or by an EDP device.

32. Set according to one of claims 26-31, characterized in that the movement of the carrier (50) with respect to the support body (60) is guided by a guide device (51, 65) to ensure directional stability.

33. Device according to claim 1, characterized in that the tube (21, 22) is mounted on the outside surface of a housing, which has an opening, and in that the tube (21, 22) is mounted so that it projects through the opening, with the result that the inlet (21b) of the tube (21, 22) is outside the housing and the outlet (21a) of the tube (21, 22) is inside the housing.

34. Set according to one of claims 26-32, characterized in that the support body (60) is mounted on the outside surface of a housing, in which an opening is provided, and in that the carrier (50) is mounted so that it projects through the opening, with the result that the inlets (21b) of the tubes (21) are outside the housing and the outlets (21a) of the tubes (21) are inside the housing.

35. Set according to claim 2, characterized in that each of the gas supply tanks (20) contains a different gas.

36. Device according to claims 8 and 21, characterized in that the drive and the adjusting mechanism can be controlled centrally by a common EDP device.

37. Device according to claims 16, 18, and 36, characterized in that the temperature of the gas supply tank (20) and the temperature of the gas feed line (19) and/or of the tube (21, 22) and/or of the cannula (13) can also be subjected centrally to open-loop or closed-loop control by the common EDP device.

38. Set according to claims 9 and 23, characterized in that each drive and each adjusting mechanism can be centrally controlled individually by a common EDP device.

39. Set according to claims 17, 19, and 38, characterized in that the temperature of each gas supply tank (20) and the temperature of each assembly (19, 21, 13) can also be subjected centrally to open-loop or closed-loop control by the common EDP device.

40. Set according to claim 31 and one of claims 38 or 39, characterized in that the displacement mechanism can also be centrally controlled either mechanically, electrically, or electronically or by the common EDP device.

41. Device according to claim 1 or set according to claim 2, characterized in that the tube (21, 22) or the tubes (21) and/or the gas supply tank or tanks (20) and/or the gas feed line or lines (19) are thermally insulated against their environment.

42. Device according to one of claims 36-40, characterized in that the device is part of an apparatus for processing the surface (14a) by gas lithography, where the apparatus also comprises a source (10), which emits a controllable beam (15) of charged particles or photons onto the surface (14a), and in that the beam (15) can also be centrally controlled by the common EDP device.

43. Method for supplying gas or liquid through a tube (21, 22) to a surface (14a), especially for producing gas mixtures or for additive or subtractive processing of the surface (14a) by gas lithography, characterized in that
the tube (21, 22) has an inlet (21b) and also an outlet (21a, 22a), located at one end, the diameter of the outlet being smaller than the inside diameter of the tube (21, 22);
a shaft (18), which extends longitudinally through the tube (21, 22), can be shifted axially with respect to the tube (21, 22) from a first position to a second position and back again;
a blocking element (18a), which is able to seal off the outlet (21a, 22a), is mounted at the front end of the shaft in such a way that the blocking element (18a) blocks off the flow of the gas or liquid through the outlet (21a, 22a) when the shaft is in the first position and releases the flow when it is in the second position; and
the inlet (21b) is connected by a gas feed line (19) to the interior space of a gas supply tank (20), so that gas can flow from the interior of the gas supply tank (20), through the gas feed line (19) and the inlet (21b), and into the tube (21, 22), where the shaft (18) is brought into the first position to block the supply of gas or liquid to the surface (14a) and into the second position to release the flow of gas or liquid.

44. Method for supplying gas or liquid through a set of tubes (21) to a surface (14a), especially for producing gas mixtures or for additive or subtractive processing of the surface (14a) by gas lithography, characterized in that
each tube (21) has an inlet (21b) and also an outlet (21a), located at one end, the diameter of the outlet being smaller than the inside diameter of the tube (21) in question;
each tube (21) has a shaft (18), which extends longitudinally through the tube (21) and which can be shifted axially with respect to the tube (21) from a first position to a second position and back again;
a blocking element (18a), which is able to seal off the outlet (21a, 22a), is mounted at the front end of each shaft (18) in such a way that the blocking element (18a) blocks the flow of gas or liquid through the outlet (21a, 22a) when the shaft is in the first position and releases the flow when the shaft is in the second position; and
each tube has a gas supply tank (20) and a gas feed line (19), by which the interior space of the gas supply tank (20) is connected to the inlet (21b) of each tube (21), so that gas can flow in each case from the interior space of the gas supply tank (20), through the gas feed line (19) and the inlet (21b), and into the tube (21, 22),
where the shaft (18) is brought into the first position to block the supply of gas or liquid to the surface (14a) and into the second position to release it.

45. Method according to claim 43 or claim 44, characterized in that the front end of the shaft (18) is inside the tube (21, 22), whereas the shaft projects beyond the tube (21, 22) in the direction opposite the flow of gas, so that the rear part of the shaft (18) is outside the tube (21, 22), where the rear part of the shaft is connected to a drive, which moves the shaft (18) from the first into the second position to release the supply of gas or liquid to the surface (14a) and from the second into the first position to block the supply.

46. Method according to claim 43 or claim 44, characterized in that a cannula (13), which is open at both ends, is mounted on the tube (21, 22), which cannula communicates with the outlet (21a, 22a), so that the gas or liquid flowing through the outlet (21a) after the release of the supply can flow through the cannula (13) and arrive at the surface (14a).

47. Method according to claim 44, characterized in that the shaft (18) is driven from the second to the first position is driven by compressed air and from the first to the second position by the force of a spring or vice versa.

48. Method according to claim 45, characterized in that the drive is controlled mechanically, electrically, or electronically or by an EDP device.

49. Method according to claim 44 and claim 48, characterized in that each drive is controlled individually either mechanically, electrically, or electronically or by a common EDP device.

50. Method according to claim 43, characterized in that the gas supply tank (20) can be heated by a heating element and/or cooled by a cooling element for the purpose of influencing the pressure of the gas inside it, and in that the temperature of the gas supply tank is subjected to open-loop or closed-loop control.

51. Method according to claim 44, characterized in that each gas supply tank (20) can be heated individually by its own heating element and/or cooled individually by its own cooling element for the purpose of influencing the pressure of the gas inside it, and in that the temperature of each gas supply tank is subjected individually to open-loop or closed-loop control.

52. Method according to claim 43, characterized in that the gas feed line (19) and the tube (21, 22) can be heated and/or cooled, and in that the temperature of the gas feed line (19) and/or of the tube (21, 22) is subjected to open-loop or closed-loop control.

53. Set according to claim 44, characterized in that the gas feed lines (19) and the tubes (21, 22) can be heated and/or cooled, where each tube (21, 22) and the gas feed line (19) leading into the tube form an assembly (19, 21), and in that the temperature of each assembly (19, 21) can be subjected individually to open-loop or closed-loop control.

54. Method according to claim 43 or claim 44, characterized in that the tube (21, 22) can be moved in the axial direction by an adjusting mechanism from a first position to a second position and back again, where the adjusting mechanism is controlled mechanically, electrically, or electronically or by an EDP device.

55. Method according to claim 54, characterized in that each tube (21) has its own adjusting mechanism, where each adjusting mechanism is individually controlled either mechanically, electrically, or electronically or by an EDP device.

56. Method according to claim 44, characterized in that the tubes (21) are mounted on or in a carrier (50), which is mounted on a support body (60), and can be shifted by a displacement mechanism with respect to the support body (60) in the direction of the surface (14a) from a rest position to a working position and back again, where the carrier is in the working position when the supply system is open and in the rest position when the supply system is closed, and in that the displacement mechanism is controlled mechanically, electrically, or electronically or by an EDP device.

57. Method according to claims 48 and 54, characterized in that the drive and the adjusting mechanism are centrally controlled by a common EDP device.

58. Method according to claims 50 and 52, characterized in that the temperature of the gas supply tank (20) and the temperature of the gas feed line (19) and/or of the tube (21, 22) are also subjected centrally to open-loop or closed-loop control by the common EDP device.

59. Method according to claims 49 and 55, characterized in that each drive and each adjusting mechanism are centrally controlled individually by a common EDP device.

60. Method according to claims 51 and 53, characterized in that the temperature of each gas supply tank (20) and the temperature of each assembly (19, 21) are also subjected centrally to open-loop or closed-loop control by the common EDP device.

61. Method according to claim 56 and one of claims 59 or 60, characterized in that the displacement mechanism is also centrally controlled either mechanically, electrically, or electronically or by the common EDP device.

62. Method according to claim 44, characterized in that the gases are supplied in succession from at least two gas supply tanks (20) to the surface (14a).

63. Method according to claim 44 or claim 62, characterized in that the gases are supplied simultaneously to the surface (14a) from at least two of the gas supply tanks (20).

64. Method according to one of claims 43-63, characterized in that the gas is supplied to the surface (14a) for the purpose of processing the surface (14a) by gas lithography, where the surface (14a) is irradiated by a controllable particle beam (15) for the purpose of exciting a chemical reaction between the gas or gases and the material of the surface (14a).

65. Method according to one of claims 43-64, characterized in that the gas is supplied to the surface (14a) for the purpose of processing the surface (14a) by gas lithography, where the surface (14a) is irradiated by a controllable photon beam (15) for the purpose of exciting a chemical reaction between the gas or gases and the material of the surface (14a).

66. Method according to one of claims 57-61 and either claim 64 or 65, characterized in that the beam (15) is also centrally controlled by the common EDP device.

67. Method according to claim 43 or claim 44 and either claim 64 or 65, characterized in that the starting and stopping of the gas feed through the tube (21, 22) is controlled as a function of time in such a way that a specific quantity of gas is conducted to the surface (14a), where this specific quantity exceeds a predetermined minimum value but does not exceed a predetermined maximum value, so that the stoichiometry of the chemical reaction is determined by the controlled timing of the starting and stopping of the gas feed.

68. Method according to claim 44 and either claim 64 or claim 65, characterized in that the starting and stopping of the gas feed is controlled as a function of time in such a way that a first specific quantity of a first gas is conducted to the surface (14a) through at least one of the tubes (21) and a second specific quantity of a second gas is conducted through at least one of the other tubes (21), where the first specific quantity exceeds a first, predetermined minimum value but does not exceed a first predetermined maximum value, and where the second specific quantity exceeds a second predetermined minimum value but does not exceed a second predetermined maximum value, so that the stoichiometry of the chemical reaction is determined by the controlled timing of the starting and stopping of the gas feed.

69. Method according to claim 43 or claim 44, characterized in that the gas or gases and the material of the surface (14a) are selected so that an exothermic chemical reaction occurs between the gas, the gases, or one of the gases and the material of the surface (14a), which reaction begins by itself upon the arrival of the gas or gases at the surface (14a), the reaction occurring in such a way that the chemical reaction covers at least a portion of the surface with a layer or removes a layer from it.

70. Method according to claim 64 or claim 65, characterized in that the gas or the gases and the material of the surface (14a) are selected so that an exothermic or endothermic chemical reaction occurs in the area of the surface (14a) exposed to the beam (15) and only there between the gas, the gases, or one of the gases and the material of the surface (14a) in such a way that, as a result of the chemical reaction, the area of the surface (1 4a) irradiated by the beam (15) is covered by a layer or a layer is removed from it.

71. Method according to claim 64 or claim 65, characterized in that
(a) first, at least two different gases are supplied in alternation to the surface (14a); and in that
(b) then at least two different gases are conducted to the surface (14a) simultaneously or in succession.

72. Method according to claim 69, characterized in that steps (a) and (b) are executed in cycles several times in succession.
